(19) United States
(12) Patent Application Publication
(10) Pub. No.: US 2021/0005203 A1
(43) Pub. Date: Jan. 7, 2021

(54) VOICE PROCESSING APPARATUS AND VOICE PROCESSING METHOD

(71) Applicant: Mitsubishi Electric Corporation, Tokyo (JP)

(72) Inventor: Michitaka INUI, Tokyo (JP)

(73) Assignee: Mitsubishi Electric Corporation, Tokyo (JP)

(21) Appl. No.: 16/955,438

(22) PCT Filed: Mar. 13, 2018
(86) PCT No.: PCT/JP2018/009699

§ 371 Date: Jun. 18, 2020

(51) Int. Cl. G10L 15/25; G10L 15/07; G10L 15/22; G10L 15/30; G10L 17/04

(52) U.S. Cl. CPC G10L 15/25; G10L 15/07; G10L 2015/227; G10L 15/30; G10L 17/04; G10L 15/22

(57) ABSTRACT

It is an object of the present invention to provide a voice processing apparatus and a voice processing method capable of reducing a communication traffic in a communication with an external server. A voice processing apparatus according to the present invention includes: an opening state detection unit detecting an opening state of a mouth of a user; and a voice information acquisition unit acquiring voice information, wherein voice identification information for identifying voice of a specific user is previously registered, the voice processing apparatus further comprises: a voice recognition unit recognizing only voice emitted in a state where the user who is registered opens a mouth as a speaker voice based on the opening state, the voice information, and the voice identification information; and a transmission unit transmitting speaker voice information which is information of the speaker voice recognized in the voice recognition unit to an external server.

### TECHNICAL FIELD

The present invention relates to a voice processing apparatus and a voice processing method of transmitting voice information of voice emitted by a user to an external server, and particularly to a voice processing apparatus and a voice processing method of transmitting voice information of voice emitted by a user to an external server in an artificial intelligence (AI) assistant in which the external server interprets contents of the voice emitted by the user and transmits necessary information to the user in response.

### BACKGROUND ART

There is an AI assistant made up of a terminal transmitting voice information of voice emitted by a user to an external server and an external server interpreting contents of the voice emitted by the user and transmitting necessary information to the user in response. The terminal and the server are connected to be able to communicate with each other via a communication line. In the AI assistant adopting such a configuration, the terminal needs to transmit only the voice information of the voice emitted by the user to the external server.

Conventionally disclosed is a technique of performing voice recognition processing on voice acquired through a microphone in a period when the user opens his/her mouth, thereby improving a voice recognition rate of the voice emitted by the user even when the user speaks in a noisy environment (refer to Patent Document 1, for example).

### PRIOR ART DOCUMENTS

### Patent Documents

Patent Document 1: Japanese Patent Application Laid-Open No. 2000-187499

### SUMMARY

### Problem to be Solved by the Invention

In Patent Document 1, the period when the user opens his/her mouth is detected as a period when the user speaks. There are problems described hereinafter in applying the technique in Patent Document 1 to the above AI assistant.

Firstly, even when the user opens his/her mouth but does not speak, that is to say, even when the user merely opens his/her mouth, the period when the user opens his/her mouth is detected as the period when the user speaks. Accordingly, the terminal transmits unnecessary information including voice information in a period when the user does not speak to the external server, thus there is a problem that a communication traffic increases.

Secondly, when the user speaks, the other sound including voice of a person other than the user is included in the voice information as a noise. Accordingly, the server cannot accurately interpret the contents of the voice emitted by the user in some cases. There is a need in this case to prompt the user to speak again, and an unnecessary communication occurs between the server and the terminal, thus there is a problem that a communication traffic increases.

The present invention therefore has been made to solve the above problems, and it is an object to provide a voice processing apparatus and a voice processing method capable of reducing a communication traffic in a communication with an external server.

### Means to Solve the Problem

In order to solve the above problems, a voice processing apparatus according to the present invention includes: an opening state detection unit detecting an opening state of a mouth of a user; and a voice information acquisition unit acquiring voice information, wherein voice identification information for identifying voice of a specific user is previously registered, the voice processing apparatus further includes: a voice recognition unit recognizing only voice emitted in a state where the user who is registered opens the mouth as a speaker voice based on the opening state detected in the opening state detection unit, the voice information acquired in the voice information acquisition unit, and the voice identification information; and a transmission unit transmitting speaker voice information which is information of the speaker voice recognized in the voice recognition unit to an external server.

A voice processing method according to the present invention includes: detecting an opening state of a user; acquiring voice information; identification information previously registered to identify voice of a specific user; recognizing only voice emitted in a state where the user who is registered opens a mouth as a speaker voice based on the opening state which is detected, the voice information which is acquired, and the identification information; and transmitting speaker voice information which is information of the speaker voice which is recognized to an external server.

### Effects of the Invention

According to the present invention, a voice processing apparatus includes: an opening state detection unit detecting an opening state of a mouth of a user; and a voice information acquisition unit acquiring voice information, wherein voice identification information for identifying voice of a specific user is previously registered, the voice processing apparatus further includes: a voice recognition unit recognizing only voice emitted in a state where the user who is registered opens the mouth as a speaker voice based on the opening state detected in the opening state detection unit, the voice information acquired in the voice information acquisition unit, and the voice identification information; and a transmission unit transmitting speaker voice information which is information of the speaker voice recognized in the voice recognition unit to an external server, thus a communication traffic in a communication with the external server can be reduced.

A voice processing method includes: detecting an opening state of a user;

acquiring voice information; identification information previously registered to identify voice of a specific user; recognizing only voice emitted in a state where the user who is registered opens the mouth as a speaker voice based on the opening state which is detected, the voice information which is acquired, and the identification information; and transmitting speaker voice information which is information of the speaker voice which is recognized to an external server, thus a communication traffic in a communication with the external server can be reduced.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram illustrating an example of a configuration of a voice processing apparatus according to an embodiment 1 of the present invention.

FIG. 2 is a block diagram illustrating an example of a configuration of the voice processing apparatus according to the embodiment 1 of the present invention.

FIG. 3 is a block diagram illustrating an example of a configuration a server according to the embodiment 1 of the present invention.

FIG. 4 is a drawing illustrating an example of a hardware configuration of the voice processing apparatus according to the embodiment 1 of the present invention and a peripheral device.

FIG. 5 is a flow chart illustrating an example of an operation of the voice processing apparatus according to the embodiment 1 of the present invention.

FIG. 6 is a flow chart illustrating an example of the operation of the voice processing apparatus according to the embodiment 1 of the present invention.

FIG. 7 is a block diagram illustrating an example of a configuration of a voice processing apparatus according to an embodiment 2 of the present invention.

FIG. 8 is a flow chart illustrating an example of the operation of the voice processing apparatus according to the embodiment 2 of the present invention.

FIG. 9 is a block diagram illustrating an example of a configuration of a voice processing system according to an embodiment of the present invention.

### DESCRIPTION OF EMBODIMENT(S)

Embodiments of the present invention are described hereinafter based on the drawings.

### Embodiment 1

<Configuration>

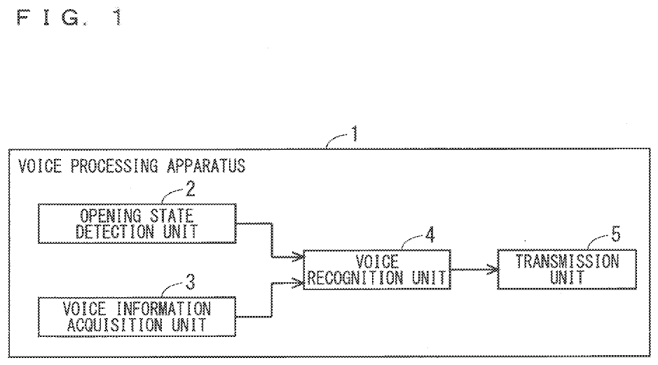

FIG. 1 is a block diagram illustrating an example of a configuration of a voice processing apparatus 1 according to an embodiment 1 of the present invention. FIG. 1 illustrates a minimum necessary configuration constituting a voice processing apparatus according to the present embodiment.

As illustrated in FIG. 1, the voice processing apparatus 1 includes an opening state detection unit 2, a voice information acquisition unit 3, a voice recognition unit 4, and a transmission unit 5. The opening state detection unit 2 detects an opening state of a mouth of a user. The voice information acquisition unit 3 acquires voice information. The voice recognition unit 4 recognizes only voice emitted in a state where a registered user opens his/her mouth as a speaker voice based on the opening state detected in the opening state detection unit 2, the voice information acquired in the voice information acquisition unit 3, and voice identification information. The voice identification information is information previously registered to identify voice of a specific user. The transmission unit 5 transmits speaker voice information which is information of the speaker voice recognized in the voice recognition unit 4 to an external server. The external server may be an AI assistant server.

The other configuration of the voice processing apparatus including the voice processing apparatus 1 in FIG. 1 is described next.

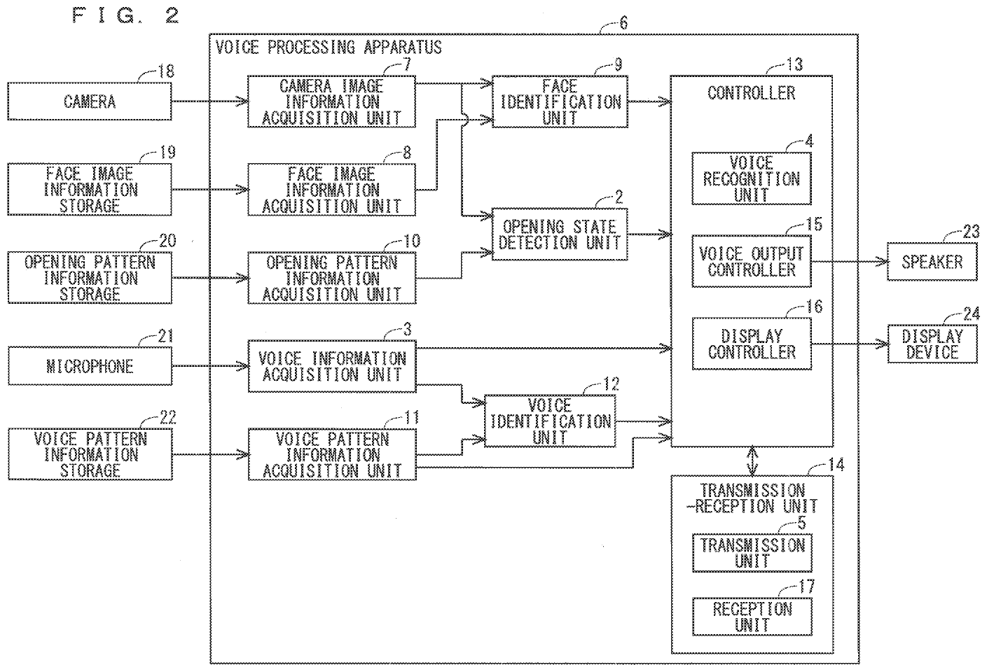

FIG. 2 is a block diagram illustrating an example of a configuration of a voice processing apparatus 6 according to the other configuration.

As illustrated in FIG. 2, the voice processing apparatus 6 includes a camera image information acquisition unit 7, a face image information acquisition unit 8, a face identification unit 9, an opening pattern information acquisition unit 10, the opening state detection unit 2, the voice information acquisition unit 3, a voice pattern information acquisition unit 11, a voice identification unit 12, a controller 13, and a transmission-reception unit 14.

The camera image information acquisition unit 7 is connected to a camera 18, and acquires camera image information which is information of a camera image taken by the camera 18.

The face image information acquisition unit 8 is connected to a face image information storage 19, and acquires face image information from the face image information storage 19. The face image information storage 19 is made up of a storage such as a hard disk drive (HDD) or a semiconductor memory, for example, and face identification information for identifying a face of a specific user is previously registered therein. That is to say, the face image information storage 19 stores a face image of a registered user as the face identification information.

The face identification unit 9 checks the camera image information acquired in the camera image information acquisition unit 7 against the face image information acquired in the face image information acquisition unit 8 to identify a user included in the camera image. That is to say, the face identification unit 9 identifies whether or not the user included in the camera image is the user whose face image is registered.

The opening pattern information acquisition unit 10 is connected to an opening pattern information storage 20, and acquires opening pattern information from the opening pattern information storage 20. The opening pattern information is information for identifying whether or not a person opens his/her mouth. The opening pattern information storage 20 is made up of a storage such as a hard disk drive or a semiconductor memory, for example, and stores the opening pattern information.

The opening state detection unit 2 detects the opening state of the user included in the camera image based on the camera image information acquired in the camera image information acquisition unit 7 and the opening pattern information acquired in the opening pattern information acquisition unit 10. That is to say, the opening state detection unit 2 detects whether or not the user included in the camera image opens his/her mouth.

The voice information acquisition unit 3 is connected to a microphone 21, and acquires the voice information from the microphone 21.

The voice pattern information acquisition unit 11 is connected to a voice pattern information storage 22, and acquires voice pattern information from the voice pattern information storage 22. The voice pattern information storage 22 is made up of a storage such as a hard disk drive or a semiconductor memory, for example, and the voice identification information for identifying voice of a specific user is previously registered therein. That is to say, the voice pattern information storage 22 stores the voice pattern information of a registered user as the voice identification information.

The voice identification unit 12 checks the voice information acquired in the voice information acquisition unit 3 against the voice pattern information acquired in the voice pattern information acquisition unit 11 to identify the user who has emitted the voice. That is to say, the voice identification unit 12 identifies whether or not the user who has emitted the voice is the user whose voice pattern information is registered.

The controller 13 includes the voice recognition unit 4, a voice output controller 15, and a display controller 16. The voice recognition unit 4 recognizes only the voice emitted in the state where the registered user opens his/her mouth as the speaker voice.

The voice output controller 15 is connected to a speaker 23, and controls the speaker 23 so that the speaker 23 outputs various types of voice. The display controller 16 is connected to a display device 24, and controls the display device 24 so that the display device 24 displays various types of information.

The transmission-reception unit 14 includes the transmission unit 5 and a reception unit 17. The transmission unit 5 transmits the speaker voice information which is the information of the speaker voice recognized in the voice recognition unit 4 to the external server. The reception unit 17 receives response information which is information transmitted from the external server in response to the speaker voice information.

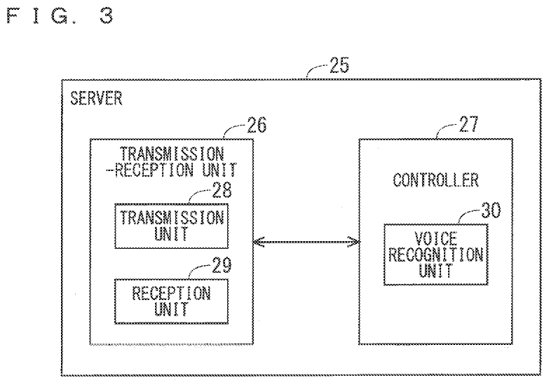

FIG. 3 is a block diagram illustrating an example of a configuration of a server 25 according to the present embodiment 1.

As illustrated in FIG. 3, the server 25 includes a transmission-reception unit 26 and a controller 27. The transmission-reception unit 26 is connected to the voice processing apparatus 6 to be able to communicate with each other via a communication line, and includes a transmission unit 28 and a reception unit 29. The transmission unit 28 transmits the response information which is the information transmitted in response to the speaker voice information to the voice processing apparatus 6. The reception unit 29 receives the speaker voice information from the voice processing apparatus 6.

The controller 27 includes a voice recognition unit 30. The voice recognition unit 30 analyzes an intention of contents of the voice emitted by the user from the speaker voice information received in the reception unit 29. The controller 27 generates the response information which is the information transmitted in response to the contents of the voice emitted by the user analyzed in the voice recognition unit 30.

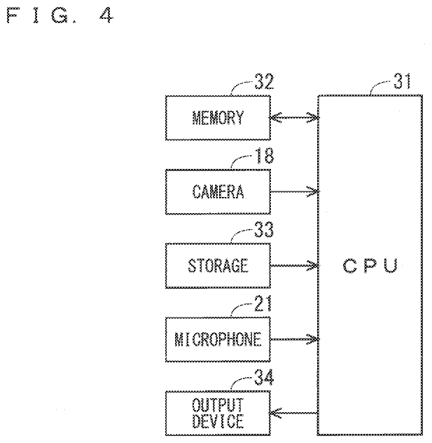

FIG. 4 is a block diagram illustrating an example of a hardware configuration of the voice processing apparatus 6 illustrated in FIG. 2 and a peripheral device. The same applies to the voice processing apparatus 1 illustrated in FIG. 1.

In FIG. 4, a central processing unit (CPU) 31 and a memory 32 correspond to the voice processing apparatus 6 illustrated in FIG. 2. A storage 33 corresponds to the face image information storage 19, the opening pattern information storage 20, and the voice pattern information storage 22 illustrated in FIG. 2. An output device 34 corresponds to the speaker 23 and the display device 24 illustrated in FIG. 2.

Each function of the camera image information acquisition unit 7, the face image information acquisition unit 8, the face identification unit 9, the opening pattern information acquisition unit 10, the opening state detection unit 2, the voice information acquisition unit 3, the voice pattern information acquisition unit 11, the voice identification unit 12, the voice recognition unit 4, the voice output controller 15, the display controller 16, the transmission unit 5, and the reception unit 17 in the voice processing apparatus 6 is achieved by a processing circuit. That is to say, the voice processing apparatus 6 includes a processing circuit for acquiring the camera image information, acquiring the face image information, identifying the user included in the camera image, acquiring the opening pattern information, detecting the opening state, acquiring the voice information, acquiring the voice pattern information, identifying the user emitting the voice, identifying only the voice emitted in the state where the registered user opens his/her mouth as the speaker voice, controlling the speaker 23 so that the speaker 23 outputs the voice, controlling the display device 24 so that the display device 24 displays the information, transmitting the speaker voice information to the external server, and receiving the response information. The processing circuit is the CPU 31 (also referred to as a central processing unit, a processing device, an arithmetic device, a microprocessor, a microcomputer, or a digital signal processor (DSP)) executing a program stored in the memory 32.

Each function of the camera image information acquisition unit 7, the face image information acquisition unit 8, the face identification unit 9, the opening pattern information acquisition unit 10, the opening state detection unit 2, the voice information acquisition unit 3, the voice pattern information acquisition unit 11, the voice identification unit 12, the voice recognition unit 4, the voice output controller 15, the display controller 16, the transmission unit 5, and the reception unit 17 in the voice processing apparatus 6 is achieved by software, firmware, or a combination of software and firmware. The software or the firmware is described as a program and is stored in the memory 32. The processing circuit reads out and executes the program stored in the memory 32, thereby achieving the function of each unit. That is to say, the voice processing apparatus 6 includes the memory 32 to store the program to resultingly execute steps of: acquiring the camera image information; acquiring the face image information; identifying the user included in the camera image; acquiring the opening pattern information; detecting the opening state; acquiring the voice information; acquiring the voice pattern information; identifying the user emitting the voice; identifying only the voice emitted in the state where the registered user opens his/her mouth as the speaker voice; controlling the speaker 23 so that the speaker 23 outputs the voice, controlling the display device 24 so that the display device 24 displays the information; transmitting the speaker voice information to the external server; and receiving the response information. These programs are also deemed to make a computer execute procedures or methods of the camera image information acquisition unit 7, the face image information acquisition unit 8, the face identification unit 9, the opening pattern information acquisition unit 10, the opening state detection unit 2, the voice information acquisition unit 3, the voice pattern information acquisition unit 11, the voice identification unit 12, the voice recognition unit 4, the voice output controller 15, the display controller 16, the transmission unit 5, and the reception unit 17. Herein, the memory may be a non-volatile or volatile semiconductor memory such as a Random Access Memory (RAM), a Read Only Memory (ROM), a flash memory, an Electrically Programmable Read Only Memory (EPROM), or an Electrically Erasable Programmable Read Only Memory (EEPROM), a magnetic disc, a flexible disc, an optical disc, a compact disc, a mini disc, or a DVD, or any storage medium which is to be used in the future.

<Operation>

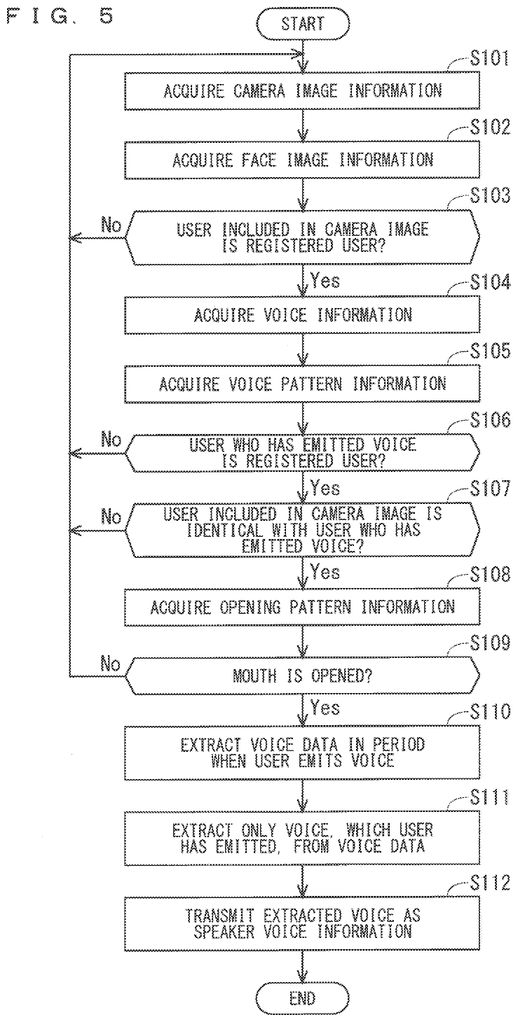

FIG. 5 is a flow chart illustrating an example of an operation of the voice processing apparatus 6, and illustrates an operation of transmitting the voice emitted by the user to the server 25. The camera 18 takes an image of only one user.

In Step S101, the camera image information acquisition unit 7 acquires the camera image information from the camera 18.

In Step S102, the face image information acquisition unit 8 acquires the face image information from the face image information storage 19.

In Step S103, the face identification unit 9 checks the camera image information acquired in the camera image information acquisition unit 7 against the face image information acquired in the face image information acquisition unit 8 to identify whether or not the user included in the camera image is the user whose face image is registered. When the user is determined to be the user whose face image is registered, the process proceeds to Step S104. In the meanwhile, when the user is not determined to be the user whose face image is registered, the process returns to Step S101.

In Step S104, the voice information acquisition unit 3 acquires voice information from the microphone 21.

In Step S105, the voice pattern information acquisition unit 11 acquires the voice pattern information from the voice pattern information storage 22.

In Step 106, the voice identification unit 12 checks the voice information acquired in the voice information acquisition unit 3 against the voice pattern information acquired in the voice pattern information acquisition unit 11 to identify whether or not the user who has emitted the voice is the user whose voice pattern information is registered. When the user is determined to be the user whose voice pattern information is registered, the process proceeds to Step S107. In the meanwhile, when the user is not determined to be the user whose voice pattern information is registered, the process returns to Step S101.

In Step S107, it is determined whether or not the user identified in Step S103 is identical with the user identified in Step S106. When the user is determined to be identical, the process proceeds to Step S108. In the meanwhile, when the user is not determined to be identical, the process returns to Step S101.

In Step S108, the opening pattern information acquisition unit 10 acquires the opening pattern information from the opening pattern information storage 20.

The opening state detection unit 2 determines whether the user included in the camera image opens his/her mouth based on the camera image information acquired in the camera image information acquisition unit 7 and the opening pattern information acquired in the opening pattern information acquisition unit 10. When the user is determined to open his/her mouth, the process proceeds to Step S110. In the meanwhile, when the user is not determined to open his/her mouth, the process returns to Step S101.

In Step S110, the voice recognition unit 4 extracts the voice data in a period when the user emits the voice. Specifically, the voice recognition unit 4 extracts the voice data in a period when the user opens his/her mouth detected in the opening state detection unit 2 from the voice information acquired in the voice information acquisition unit 3.

In Step S111, the voice recognition unit 4 extracts only the voice emitted by the user from the voice data extracted in Step S110. Specifically, the voice recognition unit 4 extracts only the voice emitted by the user based on the voice data extracted in Step S110 and the voice pattern information of the user. At this time, voice of a person other than the user included in the voice data, for example, is removed.

In Step S112, the transmission unit 5 transmits the voice extracted in Step S111 as the speaker voice information to the server 25 in accordance with a command of the controller 13.

Accordingly, when the user is a driver, for example, only the voice emitted in a state where the driver opens his/her mouth is transmitted to the server 25. The face image and the voice pattern information of the driver are previously registered, and the camera 18 takes an image of only the driver. In this case, even when a passenger other than the driver emits the voice and the voice identification unit 12 identifies that the passenger is the registered user, the passenger is not included in the camera image, thus the voice emitted by the passenger is not transmitted to the server 25. Accordingly, only the information required by the driver can be transmitted to the server 25. Examples of contents of the voice emitted by the driver includes contents regarding driving.

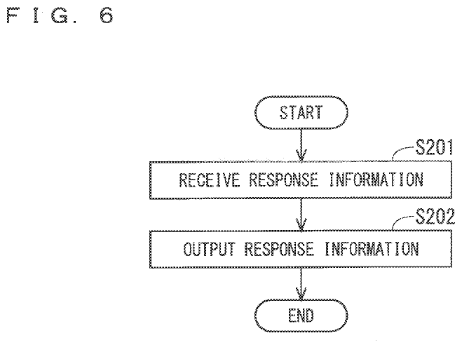

FIG. 6 is a flow chart illustrating an example of an operation of the voice processing apparatus 6, and illustrates an operation of receiving the response information from the server 25. As a premise of the operation in FIG. 6, the server 25 receives the speaker voice information from the voice processing apparatus 6, generates the response information transmitted in response to the contents of the voice emitted by the user, and transmits the response information to the voice processing apparatus 6.

In Step S201, the reception unit 17 receives the response information from the server 25.

In Step S202, the voice output controller 15 controls the speaker 23 so that the speaker 23 performs a voice output of the response information. The display controller 16 controls the display device 24 so that the display device 24 displays the response information. The response information may be both the voice output and display, or may also be either one of them.

As described above, according to the present embodiment 1, only the voice emitted in the state where the registered user opens his/her mouth is transmitted to the server. Accordingly, a communication traffic in a communication between the voice processing apparatus and the server can be reduced.

### Embodiment 2

An embodiment 2 of the present invention describes a case where a camera takes an image of a plurality of users and voice emitted by the plurality of users is transmitted to a server. The present embodiment 2 is roughly classified into a case where a face of each user is not identified and a case where a face of each user is identified.

<Case Where Face of Each User is not Identified>

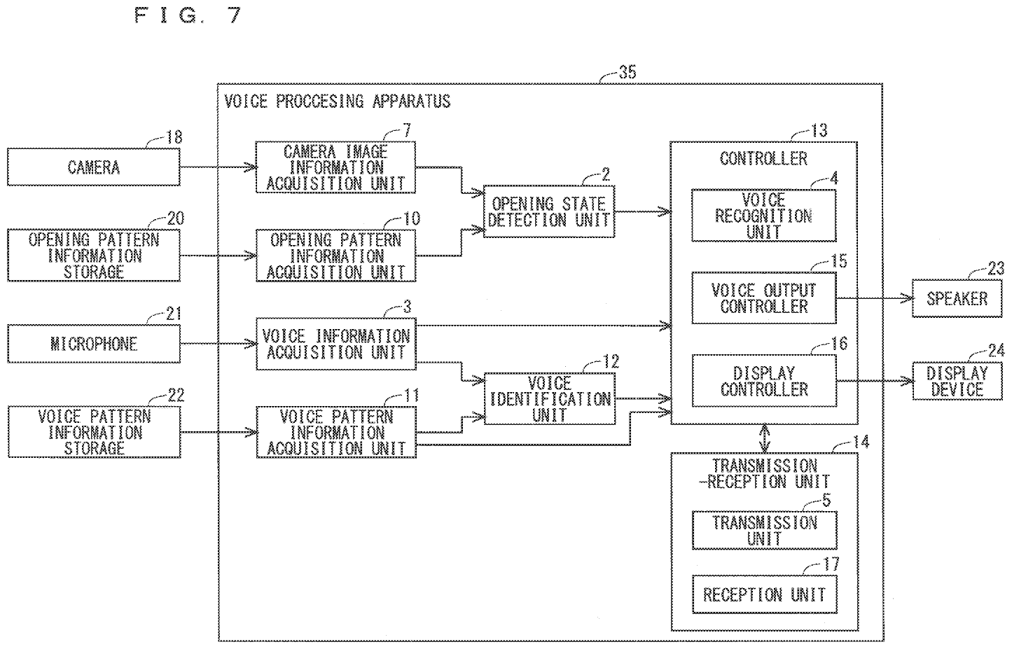

FIG. 7 is a block diagram illustrating an example of a configuration of a voice processing apparatus 35 according to the present embodiment 2.

As illustrated in FIG. 7, the voice processing apparatus 35 does not include the face image information acquisition unit 8 and the face identification unit 9 illustrated in FIG. 2. The other configuration is similar to that in the embodiment 1, thus the description is omitted herein. A configuration and operation of the server according to the present embodiment 2 are similar to those of the server 25 in the embodiment 1, thus the description is omitted herein.

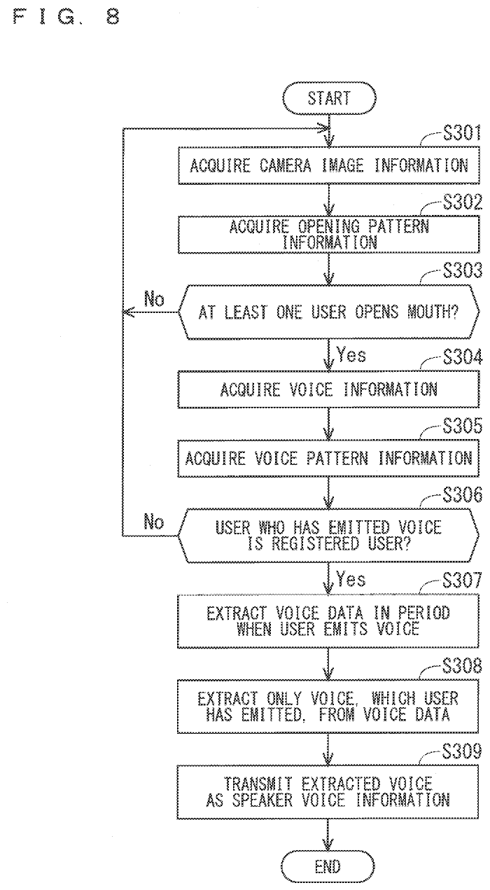

FIG. 8 is a flow chart illustrating an example of the operation of the voice processing apparatus 35, and illustrates an operation of transmitting the voice emitted by the user to the server 25. The camera 18 takes an image of the plurality of users.

In Step S301, the camera image information acquisition unit 7 acquires the camera image information from the camera 18. The camera image includes the image of the plurality of users.

In Step S302, the opening pattern information acquisition unit 10 acquires the opening pattern information from the opening pattern information storage 20.

In Step S303, the opening state detection unit 2 determines whether or not at least one user in the plurality of users included in the camera image opens his/her mouth based on the camera image information acquired in the camera image information acquisition unit 7 and the opening pattern information acquired in the opening pattern information acquisition unit 10. When at least one user is determined to open his/her mouth, the process proceeds to Step S304. In the meanwhile, when none of the all users is determined to open his/her mouth, the process returns to Step S301.

In Step S304, the voice information acquisition unit 3 acquires voice information from the microphone 21.

In Step S305, the voice pattern information acquisition unit 11 acquires the voice pattern information from the voice pattern information storage 22.

In Step 306, the voice identification unit 12 checks the voice information acquired in the voice information acquisition unit 3 against the voice pattern information acquired in the voice pattern information acquisition unit 11 to identify whether or not the user who has emitted the voice is the user whose voice pattern information is registered. When the user is determined to be the user whose voice pattern information is registered, the process proceeds to Step S307. In the meanwhile, when the user is not determined to be the user whose voice pattern information is registered, the process returns to Step S301.

In Step S307, the voice recognition unit 4 extracts the voice data in the period when the user emits the voice. Specifically, the voice recognition unit 4 extracts the voice data in the period when the user opens his/her mouth detected in the opening state detection unit 2 from the voice information acquired in the voice information acquisition unit 3.

In Step S308, the voice recognition unit 4 extracts only the voice emitted by the user from the voice data extracted in Step S307. Specifically, the voice recognition unit 4 extracts only the voice emitted by the user based on the voice data extracted in Step S307 and the voice pattern information of the user. At this time, voice of a person other than the user included in the voice data, for example, is removed.

In Step S309, the transmission unit 5 transmits the voice extracted in Step S308 as the speaker voice information to the server 25 in accordance with a command of the controller 13.

Accordingly, when the driver and the passenger in a front seat are the users and only the voice pattern information of the driver is registered, only the voice emitted in the state where the driver opens his/her mouth is transmitted to the server 25. The camera 18 takes an image of only the driver and the passenger in the front seat. In this case, the voice emitted by the passenger in the front seat is not transmitted to the server.

When the driver and the passenger in the front seat are the users and the voice pattern information of the driver and the passenger in the front seat is registered, only the voice emitted in the state where at least one of the driver and the passenger in the front seat opens his/her mouth is transmitted to the server 25. The camera 18 takes an image of only the driver and the passenger in the front seat. When the driver and the passenger in the front seat emit the voice at the same time, it is applicable that only the voice having predetermined higher priority is transmitted to the server 25, the voice is transmitted to the server 25 in order of predetermined priority, and the voice of both the driver and the passenger is transmitted to the server 25 at the same time. In this case, the voice emitted not only by the driver but also by the passenger in the front seat can be transmitted to the server 25. The contents of the voice emitted by the passenger in the front seat may be contents which does not relate to the driving such as a play procedure of music, an operation of listening to music, or a remote operation of home electronics in the home, for example.

<Case Where Face of Each User is Identified>

The configuration and operation of the voice processing apparatus are similar to those in the embodiment 1, thus the description is omitted herein.

For example, when the driver and the passenger in the front seat are the users and only the face image and the voice pattern information of the driver are previously registered, only the voice emitted in the state where the driver opens his/her mouth is transmitted to the server 25. The camera 18 takes the image of only the driver and the passenger in the front seat. In this case, the voice emitted by the passenger in the front seat is not transmitted to the server.

When the driver and the passenger in the front seat are the users and the face images and the voice pattern information of the driver and the passenger in the front seat are registered, only the voice emitted in the state where at least one of the driver and the passenger in the front seat opens his/her mouth is transmitted to the server 25. The camera 18 takes the image of only the driver and the passenger in the front seat. When the driver and the passenger in the front seat emit the voice at the same time, it is applicable that only the voice having predetermined higher priority is transmitted to the server 25, the voice is transmitted to the server 25 in order of predetermined priority, and the voice of both the driver and the passenger is transmitted to the server 25 at the same time. In this case, the voice emitted not only by the driver but also by the passenger in the front seat can be transmitted to the server 25. The voice of the user whose camera image is not included is not transmitted to the server 25 even when the face image and the voice pattern information of the user are registered.

Accordingly, according to the present embodiment 2, only the voice in the state where the plurality of registered users open their mouths is transmitted to the server. Accordingly, the communication traffic in the communication between the voice processing apparatus and the server can be reduced.

Described above is a case where the camera 18 takes the image of the driver and the passenger in the front seat, however, the configuration is not limited thereto. For example, the camera 18 may also take an image of a passenger in a rear seat in addition to the driver and the passenger in the front seat.

The voice processing apparatus described above can be applied not only to an in-vehicle navigation device, that is to say, a car navigation device but also to a navigation device such as a portable navigation device (PND) which can be mounted on a vehicle and a navigation device constructed as a system in appropriate combination with a server provided outside the vehicle, for example, or a device other than the navigation device. In this case, each function or each constituent element of the voice processing apparatus is dispersedly disposed in each function constructing the system described above.

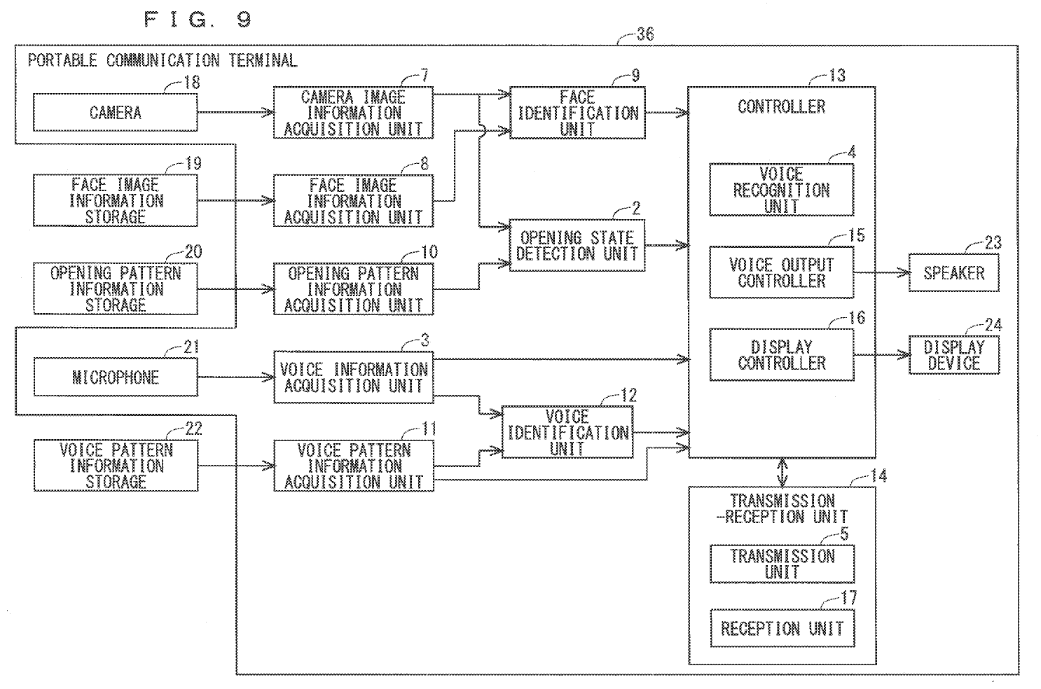

Specifically, the function of the voice processing apparatus can be disposed in a portable communication terminal as an example. For example, as illustrated in FIG. 9, a portable communication terminal 36 includes the camera image information acquisition unit 7, the face image information acquisition unit 8, the face identification unit 9, the opening pattern information acquisition unit 10, the opening state detection unit 2, the voice information acquisition unit 3, the voice pattern information acquisition unit 11, the voice identification unit 12, the voice recognition unit 4, the voice output controller 15, the display controller 16, the transmission unit 5, the reception unit 17, the camera 18, the microphone 21, the speaker 23, and the display device 24. The face image information storage 19, the opening pattern information storage 20, and the voice pattern information storage 22 are provided outside the potable communication terminal 36. A voice processing system can be constructed by applying such a configuration. The same applies to the voice processing apparatus 35 illustrated in FIG. 7.

As described above, the effect similar to that in the above embodiment can be obtained also in the configuration that each function of the voice processing apparatus is dispersedly disposed in each function constructing the system.

Software executing the operation in the above embodiment may also be incorporated into a server or a potable communication terminal, for example. A voice processing method achieved when the server or the portable communication terminal executes the software includes: detecting the opening state of the user; acquiring the voice information; identification information previously registered for identifying the voice of the specific user; recognizing only the voice emitted in the state where the registered user opens his/her mouth as the speaker voice based on the detected opening state, the acquired voice information, and the identification information; and transmitting the speaker voice information which is the information of the recognized speaker voice to the external server.

As described above, when the software executing the operation in the above embodiment is incorporated into the server or the portable communication terminal and operated, the effect similar to that in the above embodiment can be obtained.

According to the present invention, each embodiment can be arbitrarily combined, or each embodiment can be appropriately varied or omitted within the scope of the invention.

Although the present invention is described in detail, the foregoing description is in all aspects illustrative and does not restrict the invention. It is therefore understood that numerous modifications and variations can be devised without departing from the scope of the invention.

### EXPLANATION OF REFERENCE SIGNS

1 voice processing apparatus, 2 opening state detection unit, 3 voice information acquisition unit, 4 voice recognition unit, 5 transmission unit, 6 voice processing apparatus, 7 camera image information acquisition unit, 8 face image information acquisition unit, 9 face identification unit, 10 opening pattern information acquisition unit, 11 voice pattern information acquisition unit, 12 voice identification unit, 13 controller, 14 transmission-reception unit, 15 voice output controller, 16 display controller, 17 reception unit, 18 camera, 19 face image information storage, 20 opening pattern information storage, 21 microphone, 22 voice pattern information storage, 23 speaker, 24 display device, 25 server, 26 transmission-reception unit, 27 controller, 28 transmission unit, 29 reception unit, 30 voice recognition unit, 31 CPU, 32 memory, 33 storage, 34 output device, 35 voice processing apparatus, 36 portable communication terminal.

1. A voice processing apparatus, comprising:
a processor to execute a program; and
a memory to store the program which, when executed by the processor, performs processes of,
detecting an opening state of a mouth of a user; and
acquisition unit acquiring voice information, wherein
voice identification information for identifying voice of a specific user is previously registered, the voice processing apparatus further comprises:
recognizing only voice emitted in a state where the user who is registered opens the mouth as a speaker voice based on the opening state which is detected, the voice information which is acquired, and the voice identification information; and
transmitting speaker voice information which is information of the speaker voice which is recognized to an external server.

2. The voice processing apparatus according to claim 1, wherein
face identification information for identifying a face of a specific user is previously registered, and
when a user identified using the face identification information is identical with a user identified using the voice identification information, the recognizing process comprises recognizing the speaker voice of the user.

3. The voice processing apparatus according to claim 1, wherein
the user includes a plurality of user.

4. The voice processing apparatus according to claim 1, wherein
the user is a driver.

5. The voice processing apparatus according to claim 1, wherein
the program, when executed by the processor, further performs a process of receiving response information which is information transmitted from the external server in response to the speaker voice information.

6. A voice processing method, comprising:
detecting an opening state of a user;
acquiring voice information;
identification information previously registered to identify voice of a specific user;
recognizing only voice emitted in a state where the user who is registered opens a mouth as a speaker voice based on the opening state which is detected, the voice information which is acquired, and the identification information; and
transmitting speaker voice information which is information of the speaker voice which is recognized to an external server.
